(19) United States
(12) Patent Application Publication
(10) Pub. No.: US 2014/0351373 A1
(43) Pub. Date: Nov. 27, 2014

(54) METHOD FOR UPLOADING DATA TO SOCIAL NETWORKING WEBSITE AND ELECTRONIC APPARATUS USING THE METHOD

(71) Applicants: Chieh-Yu Chan, Taipei City (TW); Ming-Che Weng, Taipei City (TW); Kai-Yi Chen, Taipei City (TW); Cheng-Yuan Wei, Taipei City (TW); Jen-Shih Tsai, Taipei City (TW); Yen-Lin Lin, Taipei City (TW); Chia-Ni Chen, Taipei City (TW)

(72) Inventors: Chieh-Yu Chan, Taipei City (TW); Ming-Che Weng, Taipei City (TW); Kai-Yi Chen, Taipei City (TW); Cheng-Yuan Wei, Taipei City (TW); Jen-Shih Tsai, Taipei City (TW); Yen-Lin Lin, Taipei City (TW); Chia-Ni Chen, Taipei City (TW)

(73) Assignee: COMPAL ELECTRONICS, INC., Taipei City (TW)

(21) Appl. No.: 14/284,374

(22) Filed: May 21, 2014

Related U.S. Application Data
(60) Provisional application No. 61/827,663, filed on May 26, 2013.

(51) Int. Cl. H04L 29/08

(52) U.S. Cl. CPC H04L 67/06; H04L 67/02
USPC 709/217

(57) ABSTRACT

A method for uploading data to a social networking website and an electronic apparatus using the method are provided. The electronic apparatus automatically detects a detectable device located within a sensing range and finds a target to be tagged to set a preset tag. And the electronic apparatus uploads a geographic location, the preset tag and data to the social networking website.

### CROSS-REFERENCE TO RELATED APPLICATION

This application claims the priority benefits of U.S. provisional application Ser. No. 61/827,663, filed on May 26, 2013. The entirety of the above-mentioned patent applications is hereby incorporated by reference herein and made a part of this specification.

### BACKGROUND

1. Technical Field

The invention relates to a data sharing mechanism, and particularly relates to a method for uploading data to a social networking website and an electronic apparatus using the method.

2. Related Art

Along with people's increasing reliance on electronic products, various portable electronic apparatuses such as notebook PCs, personal digital assistants (PDAs), smartphones, pocket PCs and tablet PCs are gradually popularised. In recent years, along with booming development of social networking websites, people start to make discussions, perform interactions and share feelings and information on the social networking websites. Users share their own status, latest news or even locations with their friends, and gradually get used to upload pictures to the social networking websites to record their life.

### SUMMARY

The invention is directed to a method for uploading data to a social networking website and an electronic apparatus using the method, by which a target to be tagged to upload data is automatically listed, so as to shorten a time for a user searching the tagged target.

The invention provides a method for uploading data to a social networking website, which is adapted to an electronic apparatus, and the method is as follows. A geographic location is obtained. A detectable device located within a sensing range is detected by a sensing unit of the electronic apparatus, and it is determined whether the detectable device exists in a friend list. When it is determined that the detectable device exists in the friend list, a name of the detectable device in the friend list is set to a preset tag, and the geographic location, the preset tag and data to be uploaded are uploaded to the social networking website.

In an embodiment of the invention, the step of obtaining the geographic location includes following steps. A picture is automatically selected from an album, and the geographic location is extracted from an exchangeable image file format (Exif) message of the picture, where the picture is the data to be uploaded, and a shooting time of the picture is the closest to a current time.

In an embodiment of the invention, the step of obtaining the geographic location includes detecting the geographic location where the electronic apparatus is currently located by a positioning unit of the electronic apparatus.

In an embodiment of the invention, the step of determining whether the detectable device exists in the friend list includes following steps. An identification code is received from the detectable device. The friend list is checked for the identification code, where the friend list includes a plurality of account data, and each account data has the corresponding name. When the received identification code is conformed to a preset identification code recorded by one of the account data, it is determined that the detectable device exists in the friend list, and when the received identification code is not conformed to the preset identification code recorded by any of the account data, it is determined that the detectable device does not exist in the friend list.

In an embodiment of the invention, the method further includes transmitting the data to an email address corresponding to the name set to the preset tag.

In an embodiment of the invention, the sensing unit supports a near field communication standard.

In an embodiment of the invention, the data includes one of a message, a video and a picture, or a combination thereof.

In an embodiment of the invention, the friend list is built in the electronic apparatus, or the friend list is stored in a server of the social networking website or a server provided by a supplier of the electronic apparatus.

In an embodiment of the invention, the method further includes transmitting the name corresponding to a user of the electronic apparatus and an identification code corresponding to the electronic apparatus to a server for registration, so as to establish the friend list of the user.

The invention provides an electronic apparatus for uploading data to a social networking website including a sensing unit, a communication unit and a processing unit, where the processing unit is coupled to the sensing unit and the communication unit. The sensing unit is used for detecting a detectable device within a sensing range. The communication unit is used for connecting a network to upload data to the social networking website. When the processing unit deter mines that the detectable device exists in a friend list, the processing unit sets a name of the detectable device in the friend list to a preset tag, and uploads a geographic location, the preset tag and data to be uploaded to the social networking website through the communication unit.

According to the above descriptions, the electronic apparatus is capable of automatically detecting the surrounding detectable device, and automatically finding the target to be tagged, so as to assist the user quickly finding nearby friends to upload data to the social networking website.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic apparatus according to an embodiment of the invention.

FIG. 2 is a flowchart illustrating a method for uploading data to a social networking website according to an embodiment of the invention.

FIG. 3 is a schematic diagram of detecting detectable devices within a sensing range according to an embodiment of the invention.

FIG. 4 is a schematic diagram of a user interface according to an embodiment of the invention.

### DETAILED DESCRIPTION OF DISCLOSED EMBODIMENTS

Along with widespread of a social networking website, more and more people upload pictures, videos, articles, messages to the social networking website through electronic apparatuses for sharing. Therefore, the invention provides a method and an apparatus for uploading data to the social networking website, which are capable of shortening a time spent by the user on searching a tagged target. In order to clearly describe the content of the invention, reference will now be made in detail to the preferred embodiments of the invention.

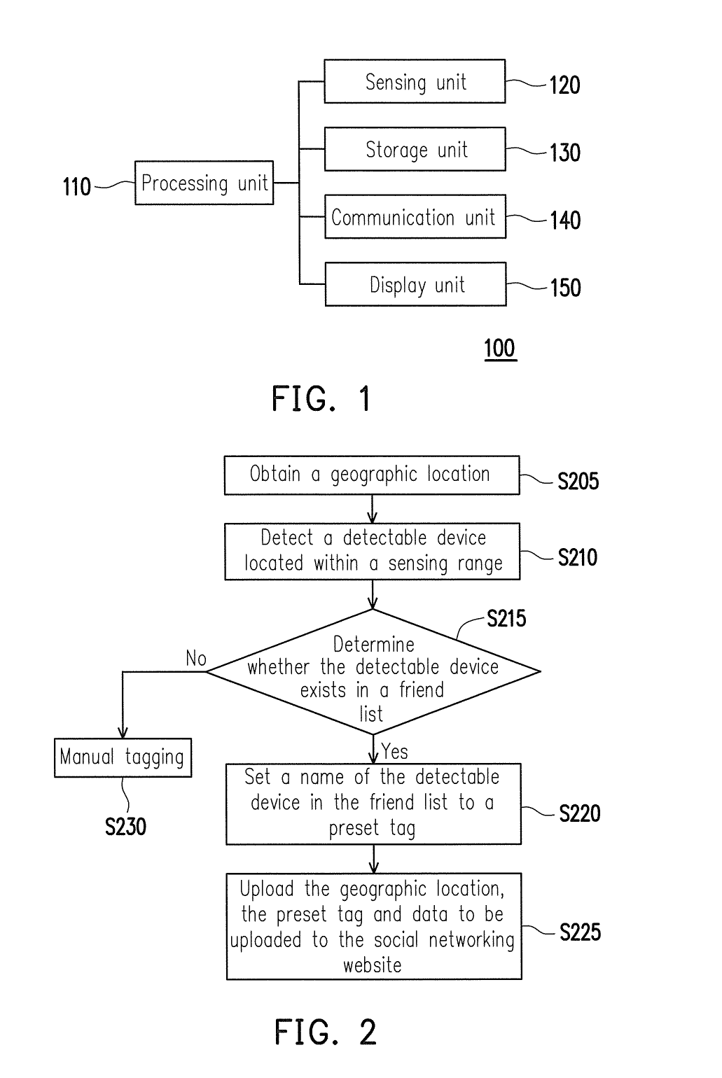

FIG. 1 is a block diagram of an electronic apparatus according to an embodiment of the invention. Referring to FIG. 1, the electronic apparatus 100 includes a processing unit 110, a sensing unit 120, a storage unit 130, a communication unit 140 and a display unit 150. The processing unit 110 is coupled to the sensing unit 120, the storage unit 130, the communication unit 140 and the display unit 150.

The processing unit 110 is, for example, a central processing unit (CPU), a programmable microprocessor, an embedded control chip, etc. The communication unit 140 is used for connecting the electronic apparatus with a network so as to connect to a social networking website. For example, the communication unit 140 can be a wired network interface card or a wireless network interface card. The processing unit 110 uploads data to the social networking website through the communication unit 140.

The sensing unit 120 is used for detecting whether a detectable device exists within a sensing range. For example, the detectable device is also configured with a sensing unit, or configured with a component suitable for being detected. The sensing unit 120, for example, supports a near field communication (NFC) standard. In other embodiments, the sensing unit 120 can also be a chip supporting other short range wireless communication standards such as a wireless fidelity (Wi-Fi) module, a bluetooth module, an infrared module, etc.

The storage unit 130 is, for example, a fixed or movable random access memory (RAM) of any type, a read-only memory (ROM), a flash memory, a hard disk or other similar devices or a combination of the devices. Here, the storage unit 130 stores a computer program. The computer program is composed of a plurality of program instructions (for example, an organization chart establishing program instruction, a table approving program instruction, a setting program instruction, and a deployment program instruction, etc), and after these program instructions are loaded into the electronic apparatus 100 and executed by the same, the processing unit 110 can upload data to the social networking website.

The display unit 150 is, for example, a liquid-crystal display (LCD), a plasma display, a vacuum fluorescent display, a light-emitting diode (LED) display, a field emission display (FED) and/or other suitable displays, which is not limited by the invention. Alternatively, the display unit 150 can also be a display having a touch module.

Moreover, the electronic apparatus 100 may also include a positioning unit and an image capturing unit. The positioning unit can be used for obtaining a current geographic location of the electronic apparatus 100, and the image capturing unit can be used for capturing an image.

FIG. 2 is a flowchart illustrating a method for uploading data to the social networking website according to an embodiment of the invention. Referring to FIG. 1 and FIG. 2, in step S205, the processing unit 110 obtains a geographic location. The geographic location can be input by the user or can be obtained from a picture, or the geographic location of the electronic apparatus 100 can be obtained through the positioning unit (not shown).

For example, when a data uploading function of the electronic apparatus 100 is enabled, the processing unit 110 automatically selects a predetermined number of pictures from an album to serve as data to be uploaded, and captures the geographic location from an exchangeable image file format message of the selected pictures. The processing unit 110 can select pictures and decide how many pictures to select base on a shooting time of each picture in the album. For example, a picture with the shooting time closest to a current time is selected, or pictures captured within a time interval before the current time are selected. For example, it is assumed that the time interval is set to one hour, and the current time is Apr. 30, 2014 AM 10:00, the processing unit 110 randomly or sequentially selects five pictures to serve as the data to be uploaded from the pictures captured within the time interval from Apr. 30, 2014 AM 9:00 to Apr. 30, 2014 AM 10:00. The five pictures are only an example, and the invention is not limited thereto. After the pictures are selected, the geographic location is extracted from the exchangeable image file format message of the selected pictures.

Moreover, the positioning unit (not shown) in the electronic apparatus 100 can be used to detect the current geographic location of the electronic apparatus 100, or the geographic location can be input by the user, which is not limited by the invention.

Moreover, in step S210, the electronic device 100 detects a detectable device located within a sensing range by the sensing unit 120. After detecting the detectable device within the sensing range, in step S215, the processing unit 110 determines whether the detectable device exists in a friend list. The friend list can be built in/stored in the electronic apparatus 100 or stored in a server. For example, the user uses the electronic apparatus 100 to register in a server, and creates the corresponding friend list in the server. The server can be provided by a supplier of the electronic apparatus 100 or can be a server of the social networking website.

In detail, the processing unit 110 is connected to a network through the communication unit 140, and transmits a name or an identification code corresponding to the user (which is referred to as a user U hereinafter) to the server for registration, so as to create corresponding account data and create a friend list related to the user U through the server. Moreover, the name corresponding to the user U is, for example, a name of the user U used in the social networking website. In addition, the processing unit 110 can also transmit an email address of the user U used for registration in the social networking website to the server for registration. The identification code can be a phone number, a serial number of the apparatus used by the user, or other numbers that can be used for identification, which is not limited by the invention. Deduced by analogy, the other users register in the server in the same way. When other account data is added to the friend list of the user U, the other account data recorded in the friend list may include the corresponding identification code (i.e. the preset identification code).

Then, the processing unit 110 can download the friend list from the server and stores the same in the storage unit 130, and after detecting the detectable device within the sensing range, the processing unit 110 checks the friend list stored in the storage unit 130 to determine whether the detectable device exists in the friend list.

After detecting the detectable device within the sensing range, the processing unit 110 receives the identification code from the detectable device. Moreover, the processing unit 110 checkes/compares the friend list for/to the identification code. The friend list includes a plurality of account data, and each account data has a corresponding name and a preset identification code. If the received identification code is conformed/does match to the preset identification code recorded in one batch of the account data, it is determined that the detectable device exists in the friend list. If the received identification code is not conformed/does not match to the preset identification code recorded in any of the account data, it is determined that the detectable device does not exist in the friend list.

On the other hand, the electronic apparatus 100 does not download the friend list, and in need of comparison, the processing unit 110 transmit the identification code received from the detectable device to the server, and the serve conducts the comparison operation.

Then, if it is determined that the detectable device exists in the friend list, in step S220, the processing unit 110 sets a name of the detectable device in the friend list to a preset tag. Namely, the user of the detectable device is set as a target to be tagged. Moreover, in step S225, the processing unit 110 uploads the geographic location, the preset tag and data to be uploaded to the social networking website, so as to post data including the preset tag and geographic location on the social networking website.

If it is determined that the detectable device does not exist in the friend list, in step S230, the user manually selects the target to be tagged. Moreover, in case that the sensing unit 120 does not detect any detectable device within the sensing range, the user can also manually select the target to be tagged.

An execution sequence of the step S205 is not limited by the invention, and the step S205 can be simultaneously executed with the step S210, or executed after the step S210, or executed after the step S220.

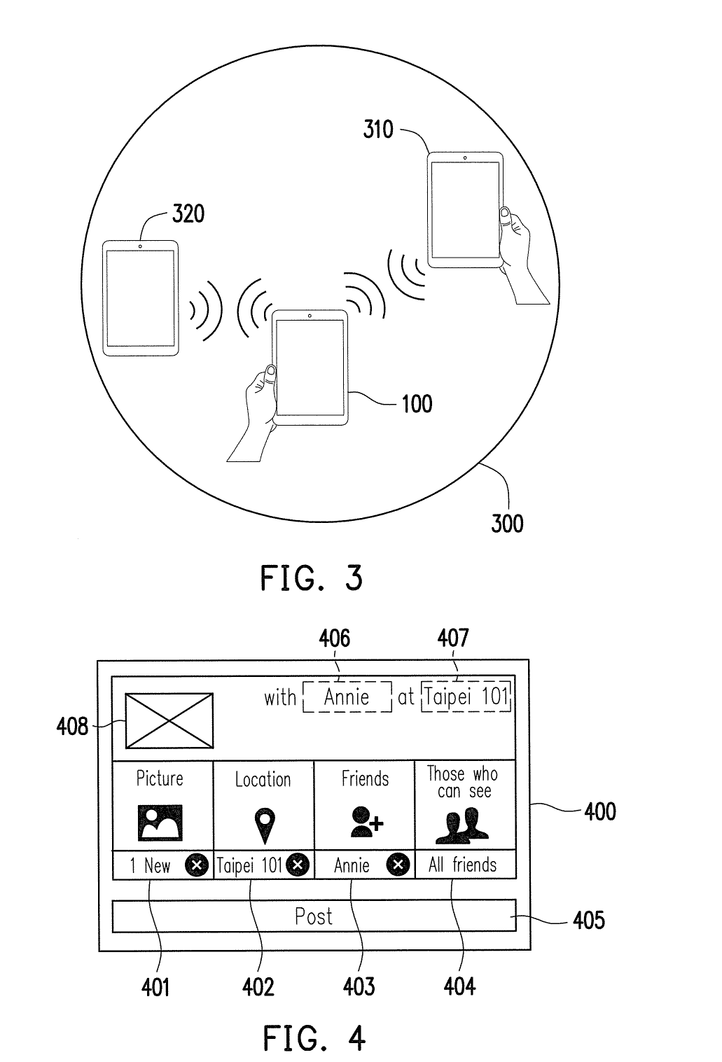

FIG. 3 is a schematic diagram of detecting detectable devices within the sensing range according to an embodiment of the invention. Referring to FIG. 1 and FIG. 3, the electronic apparatus 100 detects a detectable device 310 and a detectable device 320 within a sensing range 300 by using the sensing unit 120 (shown in FIG. 1). It is assumed that the detectable device 310 exists in the friend list of the electronic apparatus 100, and the detectable device 320 does not exist in the friend list of the electronic apparatus 100.

The electronic apparatus 100 respectively receives the identification codes form the detectable device 310 and the detectable device 320. The processing unit 110 checkes the friend list to determine whether the identification code of the detectable device 310 and the identification code of the detectable device 320 exist in the friend list, and determines that the detectable device 310 exists in the friend list of the electronic apparatus 100, and the detectable device 320 does not exist in the friend list of the electronic apparatus 100. Then, the processing unit 110 sets the name of the detectable device 310 in the friend list to a preset tag.

For example, it is assumed that the user “Angela” and her friend “Annie” go to a place (for example “Taipei 101”) together, and the user “Angela” uses the electronic apparatus 100 (having an image capturing unit) to take a picture at the site. When the user “Angela” wants to upload the picture to the social networking website, according to the aforementioned method, the user “Angela” can quickly set the nearby friend “Annie” as the target to be tagged (i.e. set the corresponding name “Annie” of her friend as the preset tag), and displays the same on the display unit 150 of the electronic apparatus 100.

Moreover, if a plurality of the detectable devices within the sensing range exist in the friend list, the names of the detectable devices are listed on the display unit 150, and the names are all set to the preset tags at first. The use can determine whether to upload all of the preset tags or upload at least one preset tag according to an actual requirement .

Moreover, an example of a user interface used for uploading data to the social networking website is introduced below. FIG. 4 is a schematic diagram of a user interface according to an embodiment of the invention. Referring to FIG. 4, the user interface 400 includes selection frames 401-404, buttons 405 and 408, and display frames 406 and 407.

The selection frame 401 is used for selecting data to be uploaded. Here, the processing unit 110 can automatically select a predetermined number of pictures (for example, the last picture) from the album to serve as preset data to be uploaded. The selection frame 402 is used for selecting a geographic location to be uploaded. Here, the current geographic location of the electronic apparatus 100 that is obtained by the positioning unit may serve as a preset location. The selection frame 403 is used for selecting the target to be tagged. Here, the processing unit 110 takes a result of the aforementioned steps S210-S220 as the preset tag. The selection frame 404 is used for selecting friends capable of seeing the data after the data is uploaded to the social networking website. The display frame 406 is used for displaying the preset tag, and the display frame 407 is used for displaying the preset location.

When a data uploading function in the electronic apparatus 100 is enabled, the processing unit 110 automatically executes the steps S205-S220, and displays a result on the user interface 400. After the confirmation, the user can press the button 405, and the processing unit 110 uploads the geographic location “Taipei 101”, the preset tag “Annie” and the data to be uploaded (pictures) to the social networking website through the communication unit 140. Moreover, after the confirmation, the user can press the button 408, and the processing unit 110 transmits data to the email address corresponding to the name set to the preset tag through the communication unit 140. In this way, a time required for manually finding the target to be tagged is saved.

In summary, the electronic apparatus is capable of automatically detecting the surrounding detectable devices, and further automatically finding the target to be tagged, the geographic location to be uploaded and the data to be uploaded, so as to assist the user quickly finding nearby friends and shorten the time used for finding the target to be tagged.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for uploading data to a social networking website, adapted to an electronic apparatus, and the method for uploading data to the social networking website comprising:
obtaining a geographic location;
detecting a detectable device located within a sensing range by a sensing unit of the electronic apparatus;
determining whether the detectable device exists in a friend list;
setting a name of the detectable device in the friend list to a preset tag when determining that the detectable device exists in the friend list; and
uploading the geographic location, the preset tag and data to be uploaded to the social networking website.

2. The method for uploading data to the social networking website as claimed in claim 1, wherein the step of obtaining the geographic location comprises:
automatically selecting a picture from an album, wherein the picture is the data to be uploaded, and a shooting time of the picture is the closest to a current time; and
extracting the geographic location from an exchangeable image file format message of the picture.

3. The method for uploading data to the social networking website as claimed in claim 1, wherein the step of obtaining the geographic location comprises:
detecting the geographic location where the electronic apparatus is currently located by a positioning unit of the electronic apparatus.

4. The method for uploading data to the social networking website as claimed in claim 1, wherein the step of determining whether the detectable device exists in the friend list comprises:
receiving an identification code from the detectable device;
checking the friend list for the received identification code, wherein the friend list comprises a plurality of account data, and each account data has the corresponding name;
determining that the detectable device exists in the friend list when the received identification code is conformed to a preset identification code recorded by one of the account data; and
determining that the detectable device does not exist in the friend list when the received identification code is not conformed to the preset identification code recorded by any of the account data.

5. The method for uploading data to the social networking website as claimed in claim 1, further comprising:
transmitting the data to an email address corresponding to the name set to the preset tag.

6. The method for uploading data to the social networking website as claimed in claim 1, wherein the sensing unit supports a near field communication standard.

7. The method for uploading data to the social networking website as claimed in claim 1, wherein the data comprises one of a message, a video and a picture, or a combination thereof.

8. The method for uploading data to the social networking website as claimed in claim 1, wherein the friend list is built in the electronic apparatus, or the friend list is stored in a server of the social networking website or a server provided by a supplier of the electronic apparatus.

9. The method for uploading data to the social networking website as claimed in claim 1, further comprising:
transmitting the name corresponding to a user of the electronic apparatus and an identification code corresponding to the electronic apparatus to a server for registration, so as to establish the friend list of the user.

10. An electronic apparatus for uploading data to a social networking website, comprising:
a sensing unit, detecting a detectable device within a sensing range;
a communication unit, connecting a network to upload data to the social networking website; and
a processing unit, coupled to the sensing unit and the communication unit, wherein when the processing unit determines that the detectable device exists in a friend list, the processing unit sets a name of the detectable device in the friend list to a preset tag, and uploads a geographic location, the preset tag and data to be uploaded to the social networking website through the communication unit.
